(19) United States
(12) Patent Application Publication
(10) Pub. No.: US 2020/0353616 A1
(43) Pub. Date: Nov. 12, 2020

(54) METHOD OF CONTROL OF BRAKE DEVICES IN A ROBOT SYSTEM AND ROBOT

(71) Applicant: FRANKA EMIKA GmbH, Munich (DE)

(72) Inventors: Andreas SPENNINGER, Karlsfeld (DE); Dmitrij FORSSILOW, Munich (DE)

(21) Appl. No.: 16/869,652

(22) Filed: May 8, 2020

(30) Foreign Application Priority Data
May 8, 2019 (DE) 10 2019 112 024.1

(51) Int. Cl. B25J 9/16; F16D 63/00; F16D 65/16; F16D 66/00

(52) U.S. Cl. CPC B25J 9/1628; F16D 63/006; F16D 2121/24; F16D 66/00; F16D 65/16

(57) ABSTRACT

A method for controlling a braking device for a drive unit of a joint between two members of a multi-axis robot arm of an articulated arm robot including a brake activation device and a locking element, wherein the drive unit includes a rotor with at least two radial brake elements, wherein the brake elements are rotated such that the locking element is always exposed. Further described is a method for determining the positions of the radial brake elements.

### FIELD OF THE INVENTION

The present invention relates to methods for controlling a braking device for a drive unit of a joint between two members of a multi-axis robot arm of an articulated arm robot and to corresponding robot systems.

### BACKGROUND OF THE INVENTION

In particular for robots for use in the field of human-robot collaboration (HRC) it is mandatory to provide for safety reasons an emergency stop or braking device in case of malfunction or sudden failure of the power supply, which is designed to stop the robot arm as quickly as possible in order to prevent injuries to an operator of the robot system or to prevent the object manipulated by the robot arm in the course of the activity to be performed by the robot arm or the robot arm itself from being damaged. Such an emergency stop can also be caused directly by the user, for example by pressing an emergency switch.

For example, braking devices are known for articulated arm robots in a wide variety of designs, with the aid of which the movement of the robot arm can be brought to an abrupt stop, at least to a very rapid stop within a defined period of time.

European Patent No. 3 045 273 discloses a braking mechanism in which a friction ring is mounted coaxially with the motor shaft, with which a pin of a locking device cooperates by engaging the pin radially in the friction ring in an emergency. Due to the fact that the friction ring is rotatable relative to the motor shaft under a defined frictional engagement, a slight braking delay of the rotational movement is realized when the radial pin engages.

The German patent application no. 10 2015 116 609 A1 discloses a braking device in which a brake star is non-rotatably arranged on the motor shaft of the drive unit, which has six radially protruding teeth arranged equidistantly in the circumferential direction. A brake activation device is provided coaxially to the axis of the motor shaft, which forces a locking bolt into the rotational range of the brake star when required, e.g. during emergency braking, so that one tooth of the brake star comes into engagement with the locking bolt. Such a braking device can also be designed to lock each joint of a multi-axis robot arm in the respective position when the robot is at a standstill.

However, under certain circumstances, the engagement between the locking element and the brake element may not release by itself, since in the position of the robot arm frozen in the emergency stop, static forces act on the joint and its components, such as a leverage effect resulting from the robot's own weight or from the weight of an object gripped by the robot. These lever forces can cause the locking element or bolt to jam with the brake element or tooth, thereby blocking the braking device for subsequent release. In this case, the robot must be reactivated or released before it is started up again, releasing the mechanical blockages of the braking devices in the joints where these have actually occurred.

To do this, the braking device can be loosened or released, for example, by using a tool designed for this purpose to return the locking element to its initial position by mechanical intervention. This procedure is not only time-consuming, as it may have to be carried out for several joints, but also carries the risk of mechanical damage to individual joint and brake components.

It is also possible that the drive units are actively started-up in both directions of rotation until the blockages are released again. If necessary, this must also be done individually for several or even all joints of a multi-axis articulated arm robot. This means that in order to release the braking devices for each axis, one member is first moved relative to the other member of the multi-axis robot arm in one direction of rotation. If the bolt cannot be released with the help of the tool even then, because the gravity causes the brake star to rest on the bolt, the robot is moved in the opposite direction of rotation. In other words, it must be tried out in which direction of rotation the braking device can actually be released, i.e. the bolt can be released from the brake star and returned to its release position, especially since the individual angular positions of the teeth of the brake star in relation to the motor position or motor shaft position and thus also in relation to the bolt position are not known in this way.

Of course, this process is time-consuming. In addition, the use of a tool to loosen the bolt makes it impossible to avoid signs of wear in the drive unit and especially on the brake star. In addition, at least one access opening in the housing of the robot arm must be provided for the engagement of a tool specially designed to release the bolt; the drive unit itself, particularly in the area of the braking device, must be freely accessible to the tool, which limits the overall design scope from the outset.

### SUMMARY

In light of the foregoing, one objective of the invention is to facilitate the release of braking devices for drive units of joints between members of a multi-axis robot arm, in particular of lightweight construction, and, if possible, to avoid the need for manual intervention. In addition, it is a further objective of the invention to provide a braking device of the aforementioned type with a brake star, in which the relative positions of the elements interacting with each other during braking can be determined in advance in a simple manner

The first-mentioned objective is solved according to the invention by a method for controlling a braking device for a drive unit of a joint between two members of a multi-axis robot arm of an articulated arm robot according to claim 1. The further objective is solved according to the invention by a method for controlling such a braking device according to claim 12.

Accordingly, the invention relates in a first aspect to a method for controlling a braking device for a drive unit of a joint between two members of a multi-axis robot arm of an articulated arm robot comprising a brake activation device and a locking element, wherein the drive unit comprises a rotor with at least two radial brake elements, each enclosing a free circumferential segment therebetween in the circumferential direction, and wherein the brake activation device is adapted to bring the locking member into engagement with at least one brake element as required to stop rotation of the rotor, the method comprising the steps of

a) detecting the current positions of the at least two brake elements;

b) determining of that circumferential segment in which the locking element is located; and

c) within the determined circumferential segment, detecting the respective distances of the at least two brake elements to the locking element.

The current positions can be detected by means of known encoders, position sensors and the like, which interact with the respective elements in an appropriate way. A control of the robot system or at least of the joint can have corresponding evaluation algorithms for this.

The method further comprises the step of d) depending on the detected distances, rotating the brake elements relative to the locking element by at least such an angle that the locking element is completely exposed on both sides in the determined circumferential segment.

According to the invention, it is ensured in this way that the bolt at no time after braking is applied or attached to the rotor, which can be designed as a brake star, or to a radial brake element thereof, in such a way that the braking device as a whole is rotationally locked.

Preferably the angle is selected so that the locking element in the circumferential segment is arranged at equal distances from the brake elements enclosing it, in order to completely eliminate the risk of blocking.

According to the invention, it can also be additionally provided that the motor is controlled in such a way that the rotor together with the brake elements is to rotate by a complete segment width of the circumferential segment, so that a control step is provided, since the position of the locking element would be covered in any case if it were rotated by such a dimension.

In order to release the robot arm again after emergency braking or after a desired blocking of the robot arm at standstill, step e) is followed by a release of the locking element in this position.

Ideally, the above steps of the method according to the invention are carried out successively for a first joint of the multi-axis robot arm, and if the release with respect to this first joint is successful, steps a) to e) of the method are carried out for a second joint following the first joint.

In a preferred embodiment of this method, steps a) to e) are performed consecutively in one of the two sequences of joints of the multi-axis robot arm, one for each joint individually. In other words, all braking devices of the individual joints of the robot arm are released from its one end, e.g. the distal end carrying an effector, to its other end, e.g. the stationary base, or vice versa.

In a preferred embodiment of the method, the status of the release per joint is monitored, e.g. by means of an appropriate sampling of the status of the brake activation device. If, for any reason, the release in a braking device of a joint has not been carried out correctly, a control of the robot is designed to actively lock braking devices that have already been released, i.e. to bring the bolt into engagement with the brake element. This prevents the robot arm from moving uncontrolled due to gravitational forces or active control.

In accordance with a further development of the method, step a) of detecting the current positions of the at least two brake elements can be implemented by determining, preferably calculating, the positions from stored absolute positions of the at least two brake elements in relation to an absolute position of the rotor or the motor shaft detected by means of an encoder and thus to the absolute position of the locking element arranged stationary relative to the motor shaft.

Before carrying out one of steps a) to c), it may therefore be necessary to acquire or detect the absolute positions of the at least two brake elements in relation to the rotor and thus to the motor position.

As already mentioned, this can be done physically by sensing corresponding values by means of corresponding rotary position sensors and the like, e.g. by means of Hall elements known per se; preferably, however, according to the invention, these positions are to be determined, i.e. preferably calculated, by means of a correspondingly designed control logic.

This eliminates the need to use additional sensors and place them in suitable locations within the braking device. As a result, the installation space for the braking device and thus the drive unit need not be unnecessarily restricted.

Therefore, the method may be designed according to the invention that the step of detecting the absolute positions comprises the steps
actuating the locking element; and
rotating the brake elements until a first brake element comes to rest against the locking element under a defined torque;
detecting the position of the blocked first brake element;
releasing the locking element;
rotating the brake elements until a second brake element comes to rest against the locking element under a defined torque; and
detecting of the position of the blocked second brake element.

The rotor usually has several, preferably three, brake elements equidistantly arranged in the circumferential direction, so that therefore, according to the invention, the aforementioned steps are repeated according to the number of brake elements present, whereby this can be carried out in one direction of rotation, or successively in both directions of rotation. In this way a higher number of measured values can be obtained, which increases the accuracy of the position determination. In particular, the influences of possible tolerance errors can be excluded.

The determination of the positions as such has in itself an independent inventive step. For these reasons, the present invention relates in a further aspect, separately or combined with the method described above, to a method for controlling a braking device for a drive unit of a joint between two members of a multi-axis robot arm of an articulated arm robot comprising a brake activation device and a locking element, wherein said drive unit comprises a rotor having at least two radial brake elements each circumferentially enclosing a free circumferential segment therebetween, and wherein said brake activation device is adapted to bring said locking element into engagement with a brake element as required to stop rotation of said rotor, said method comprising the steps of
actuating the locking element;
rotating the brake elements until a first brake element comes to rest against the locking element under a defined torque;
detecting the position of the blocked first brake element;
releasing the locking element;
rotating the brake elements until a second brake element comes to rest against the locking element under a defined torque;
detecting the position of the blocked second brake element; and
setting or defining of the detected positions as absolute positions of the brake elements in relation to an absolute position of the rotor, which is preferably measured and reflects the motor position.

Ideally, these steps are carried out immediately after completion of the assembly of such a robot arm and during start of operation. In other words, the motor of the drive unit drives the rotor with the brake star and is controlled against the bolt that is in a locked position, applying a sufficiently high current to ensure that the bolt is always in contact with a radial brake element of the brake star. The bolt is then released and the brake star is moved by the respective distance (i.e. short or long distance) within the circumferential segment in which the bolt initially lies.

In a further development of the method, the torque when the locking element is in contact with the brake element can be varied to ensure that the bolt is actually in full contact.

By means of this method according to the invention, it is possible to “measure” the brake star as it were. It is therefore not necessary to manufacture it with high tolerances. Any deformations occurring during installation of the brake star have no influence.

The absolute positions obtained in this way are preferably stored in a memory assigned to the joint in the drive unit. This has the advantage that when a drive unit is removed and then installed again, the position data once determined need not be recorded again. In this respect, the braking device therefore no longer needs to be calibrated unless maintenance or repair work had to be carried out directly on it or components of it had to be replaced. The relevant data can, however, also be stored in a master controller of the robot system, in particular in addition to it.

The above-mentioned steps must therefore be repeated exactly twice as often as the number of brake elements equidistantly arranged on the rotor, since each brake element can come into contact with the bolts from both sides, depending on the direction of rotation. Consequently, these steps can be carried out in one direction of rotation, or one after the other in both directions of rotation, individually for each joint of a multi-axis articulated arm robot.

The positions once determined according to the method according to the invention do not change as long as the relative position of the brake star in relation to the motor shaft or the rotor does not change, e.g. slips due to friction as in the state of the art. For these reasons, it is intended that the brake star is connected to the rotor in a rotationally fixed, e.g. adhesive, manner.

Furthermore, the invention relates in each case to a computer program, comprising program instructions which cause a processor to execute and/or control the steps of the methods according to the two aspects described when the computer program is running on the processor, as well as a data carrier device relating thereto. Likewise, the invention relates to a respective computer system with a data processing device, wherein the data processing device is designed in such a way that the methods according to the two aspects described are executed on the data processing device.

Furthermore, the invention also relates to a robot system with a multi-axis robot arm having means for carrying out the methods according to the two aspects described.

### BRIEF DESCRIPTION OF THE FIGURES

Further advantages and features of the present invention result from the description of the embodiment shown in the enclosed drawings.

FIG. 1 is an example of a perspective view of a braking device according to the invention; and

FIG. 2 is a schematic representation of the segments of a brake star and the positions of the individual elements in relation to these segments.

### DETAILED DESCRIPTION

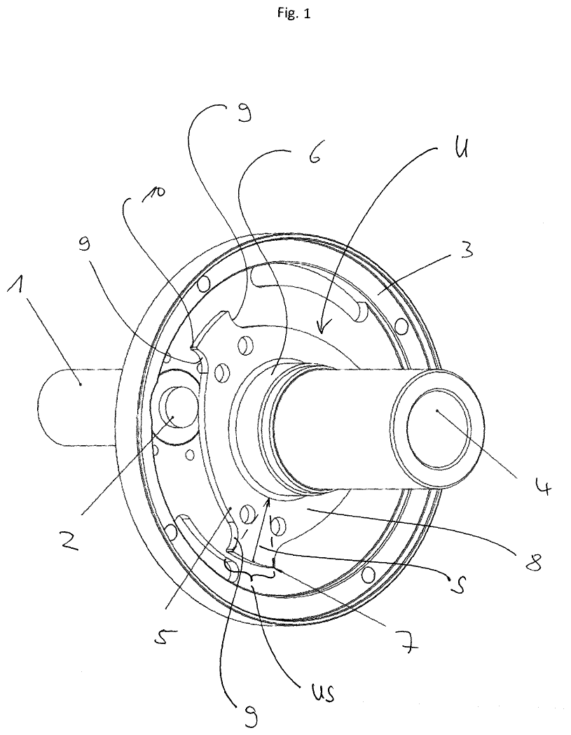

The braking device shown schematically in FIG. 1 according to the invention can preferably be attached to the front face of one end of a drive unit of a joint between two members of a robot arm, preferably in a joint unit as described in German patent application No. 10 2016 004 787.9.

The braking device according to the invention comprises a brake activation device 1, which may be a magnet-activated holding or spring mechanism, for example. The brake activation device 1 is conceived and designed to activate a locking element in the form of a bolt 2 when required, e.g. in the event of an unexpected power failure, whereby the bolt 2 is then driven upwards, e.g. by a spring.

By means of a bearing disk 3, which is fixed to the housing, i.e. connected to a (not shown) housing of the drive unit, a motor shaft or a rotor 4 of the drive unit can be supported by known bearings (not shown). The brake activation device 1 with the bolt 2 is arranged stationary on the bearing disk 3.

The rotor 4 carries a brake element in the form of a brake star 5, which is connected, e.g. glued, to the rotor 4 in a rotationally fixed manner via an axially extending sleeve 6.

The brake star 5 comprises three webs 7 spaced at an equal circumferential angle to each other, which extend radially from an inner ring 8 of the brake star 5.

By means of the preferably solenoid-operated brake activation device 1, bolt 2 can be moved between a locked position, in which it remains without energy supply, and a release position to be taken up when energy is supplied. FIG. 1 shows bolt 2 in such a release position; this bolt 2 is located underneath the rotating brake star 5, seen in the axial direction, and is therefore out of engagement with one of the webs 7. When the energy is switched off, the bolt is forced towards the brake star 5 by the spring force of a spring, which is then released by a magnet which is no longer activated, and thus passes between two adjacent webs 7 of the rotating brake star 5, whereby an abrupt braking of the drive shaft or the rotor 4 is realized as soon as the next web 7 hits against the bolt 2.

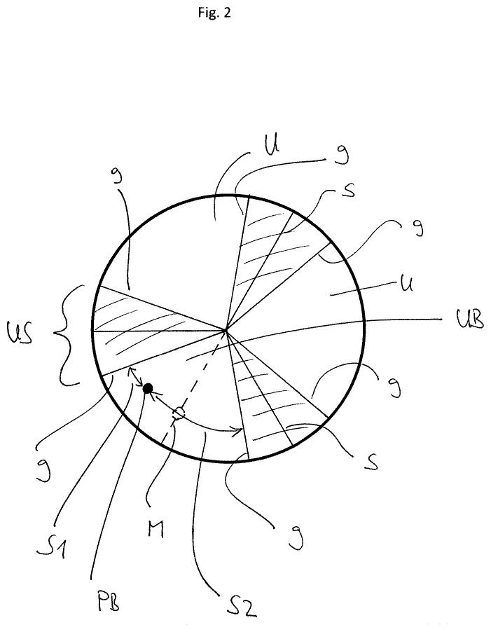

FIG. 2 schematically shows the segmentation of the brake star 5 with the relative positions of the individual webs 7 and the bolt 2.

The webs 7 are arranged at an equal distance from each other, i.e. with three webs 7, their central radial axes S are 120° apart. Since the webs 7 themselves have a certain width, as shown in FIG. 1, e.g. a circumferential extension US of 40°, the edges 9 of the webs 7, against which the bolt 2 comes to rest, include free circumferential segments U with an angular extension of 80°.

Since the positions of the edges 9 on both sides of each web 7 in relation to the angular position of the rotor 4 and thus the motor position have been determined and stored in advance, if necessary by a separate measuring method, and since the absolute, since stationary position PB of bolt 2 is known, it can then be determined by means of the detection of the angular position of the rotor 4 or of the motor shaft in the control system, where the individual positions of the edges 9 are located, and thus that circumferential segment UB can be determined in which bolt 2 is actually located after braking or locking has been carried out.

From this, the circumferential distances S1 and S2 of bolt 2 to the edges 9 enclosing the circumferential segment UB can be calculated.

The control system according to the invention is designed in such a way that, depending on the detected and calculated positions, the brake star 5 is then rotated in such a direction that the bolt 2 is certainly located freely in the circumferential segment UB, i.e. without risk of contact and thus blockage with one of the edges 9 of the adjacent webs 7, preferably in such a way that the distance S1 is equal to the distance S2, i.e. the bolt 2 lies on a central line M of the circumferential segment UB.

In this position, bolt 2 can then be transferred to its release position, i.e. the braking device can be released. According to the invention, this is preferably then carried out by an active control of the brake activation device 1, which retracts bolt 2 into its release position.

The steps described above are carried out individually, preferably consecutively from one end to the other end, for each joint of the multi-axis robot arm when a robot is activated.

1. A method for controlling a braking device for a drive unit of a joint between two members of a multi-axis robot arm of an articulated arm robot comprising a brake activation device and a locking element, wherein the drive unit comprises a rotor with at least two radial brake elements, each enclosing a free circumferential segment (U) therebetween in the circumferential direction, and wherein the brake activation device is adapted to bring the locking element into engagement with at least one brake element when required to stop rotation of the rotor, the method comprising the steps of
a) detecting the current positions of said at least two brake elements;
b) determining of that circumferential segment (UB) in which the locking element is located; and
c) detecting within the determined circumferential segment (UB) the respective distances (S1, S2) of the at least two brake elements from the locking element.

2. The method according to claim 1, further comprising the step:
d) depending on the detected distances (S1, S2), rotating the brake elements relative to the locking element by at least such an angle that the locking element is exposed in the determined circumferential segment (UB).

3. The method according to claim 2, in which the angle is selected such that the locking element is arranged at equal distances from the brake elements enclosing it.

4. The method according to claim 2, further comprising the step
e) releasing the locking element in this position.

5. The method according to claim 4, in which the steps a) to e) of the method are carried out for a first joint of the multi-axis robot arm, and upon successful release, the steps a) to e) of the method are carried out for a second joint following the first joint.

6. The method according to claim 5, in which the steps a) to e) of the method are carried out consecutively in one of the two sequences of the joints of the multi-axis robot arm separately for each joint.

7. The method according to claim 1, in which the step a) of detecting the current positions of the at least two brake elements comprises:
determining the positions from stored absolute positions of the at least two brake elements in relation to an absolute position of the rotor and/or the locking element.

8. The method according to claim 7, before carrying out one of steps a) to c), further comprising the step:
detecting the absolute positions of the at least two brake elements in relation to the rotor.

9. The method according to claim 8, in which the step of detecting absolute positions comprises the steps
actuating the locking member; and
rotating the brake elements until a first brake element comes to rest against the locking element under a defined torque;
detecting the position of the blocked first brake element;
releasing the locking element;
rotating the brake elements until a second brake element comes to rest against the locking element under a defined torque; and
detecting of the position of the blocked second brake element.

10. The method according to claim 8, in which the rotor has a plurality of brake elements arranged equidistantly in the circumferential direction, comprising
repeating the steps according to the number of brake elements present.

11. The method according to claim 10, in which the steps are carried out in one rotational direction; or successively in both rotational directions.

12. A method for controlling a braking device for a drive unit of a joint between two members of a multi-axis robot arm of an articulated arm robot comprising a brake activation device and a locking element, wherein the drive unit comprises a rotor with at least two radial brake elements, each enclosing a free circumferential segment (U) therebetween in the circumferential direction, and wherein the brake activation device is adapted to bring the locking member into engagement with a brake member when required to stop rotation of the rotor, the method comprising the steps of
actuating the locking member;
rotating the brake elements until a first brake element comes to rest against the locking element under a defined torque;
detecting the position of the blocked first brake element;
releasing the locking element;
rotating the brake elements until a second brake element comes to rest against the locking element under a defined torque;
detecting the position of the blocked second brake element; and
defining the detected positions as absolute positions of the brake elements in relation to an absolute position of the rotor.

13. The method according to claim 12, in which the torque is varied when the locking element rests against the brake element.

14. The method according to claim 12, in which the absolute positions are stored in a memory associated with the joint in the drive unit.

15. The method according to claim 12, in which the rotor comprises a plurality of equidistantly arranged brake elements, comprising the step
repeating the steps according to the number of brake elements present.

16. The method according to claim 15, in which these steps are carried out in one direction of rotation; or one after the other in both directions of rotation.

17. The method according to claim 12, in which the method is carried out individually for each joint of a multi-axis articulated arm robot.

18. A computer program comprising program instructions which cause a processor to execute and/or control the steps of the method according to claim 1 when the computer program is running on the processor.

19. A data carrier device on which a computer program according to claim 18 is stored.

20. A computer system comprising a data processing apparatus, the data processing apparatus being arranged such that the method according to claim 12 is performed on the data processing apparatus.

21. A robot system with a multi-axis robot arm comprising means for carrying out the process according to claim 1.
